(19) United States
(12) Patent Application Publication
(10) Pub. No.: US 2012/0246017 A1
(43) Pub. Date: Sep. 27, 2012

(54) DISTRIBUTING CONTENT

(75) Inventor: Michael Kleber, Newton, MA (US)

(73) Assignee: Google Inc., Mountain View, CA (US)

(21) Appl. No.: 13/514,820

(22) PCT Filed: Nov. 24, 2010
(86) PCT No.: PCT/US10/58074

§ 371 Date: Jun. 8, 2012

Related U.S. Application Data
(60) Provisional application No. 61/290,346, filed on Dec. 28, 2009.

(51) Int. Cl. G06F 17/00; G06Q 30/02

(52) U.S. Cl. 705/14.73; 715/234

(57) ABSTRACT

Rendering a web page that includes content from multiple web sites includes executing a first operation to create an empty iframe on a web page being rendered. The iframe is created without content. A second operation is executed to place content in the iframe. The content includes a script tag to download and execute a script from a web site. Based on the script tag, the script from the web site is downloaded and executed. An additional operation is executed to render the web page concurrently with executing at least one operation in the script downloaded from the web site. The web site is a second web site that is different from a first web site that supplied the instructions to render the web page. The rendered web page includes content from the first web site and content from the second web site.

### CROSS-REFERENCE TO RELATED APPLICATION

This application claims priority to U.S. Application No. 61/290,346, filed on Dec. 28, 2009, entitled DISTRIBUTING CONTENT, the disclosure of which is incorporated herein by reference.

### TECHNICAL FIELD

This disclosure relates to distributing content.

### BACKGROUND

In many different environments, content providers want to distribute content to selected individuals for review. For example, advertisers want to distribute their advertisements where the advertisements will be effective in communicating information to receptive recipients, and at times when the advertisements will lead to desired activity, such as a purchase of the advertiser's goods or services. Content can be distributed electronically, such as by using a network of computers and other types of electronic devices.

### SUMMARY

In one general aspect, rendering a web page includes executing a first operation to create an empty iframe on a web page being rendered. The iframe is created without content. A second operation is executed to place content in the iframe. The content includes a script tag to download and execute a script from a web site. The second operation is different from the first operation. Based on the script tag, the script from the web site is downloaded and executed. An additional operation is executed to render the web page concurrently with executing at least one operation in the script downloaded from the web site. The additional operation is an operation other than the first operation and the second operation. The web site is a second web site that is different from a first web site that supplied the instructions to render the web page. The rendered web page includes content from the first web site and content from the second web site.

Implementations may include one or more of the following features. For example, the first operation may include an operation to create an iframe without a source attribute. The first operation may include an operation to create an iframe having a document object that is blank. The second operation may include a JavaScript document.write( )method.

The script tag may identify an external source, and the JavaScript document.write( )method may inject the script tag into the iframe. The script downloaded from the second web site may include a command to close a document object in the iframe. The script downloaded from the second web site may include a calls to a JavaScript document.close( )method. The web page may include content from a publisher site, and the iframe on the web page may display an advertisement on the rendered page.

The operations may include downloading a publisher script from the first web site, and executing the publisher script to download a first advertisement script from the second web site. Executing the first advertisement script may include executing the first operation to create the empty iframe. Executing the second operation may include placing, in the iframe, a script tag identifying a second advertisement script from the second web site.

Implementations of the techniques discussed above may include a method or process, a system or apparatus, or computer software embedded on a computer-accessible medium. The details of one or more implementations are set forth in the accompanying drawings and the description below. Other features and advantages will become apparent from the description, the drawings, and the claims.

### BRIEF DESCRIPTION OF THE DRAWINGS

FIG. 1 is a block diagram of an example system for distributing content.

FIG. 2 is a block diagram of an example web browser user interface.

FIG. 3 is a flow chart of an example process for rendering a web page including content from multiple web sites.

FIG. 4 is a block diagram of an example system for distributing content.

FIG. 5 is block diagram of an example computer system that can be used to distribute content.

Like reference numbers and designations in the various drawings indicate like elements.

### DETAILED DESCRIPTION

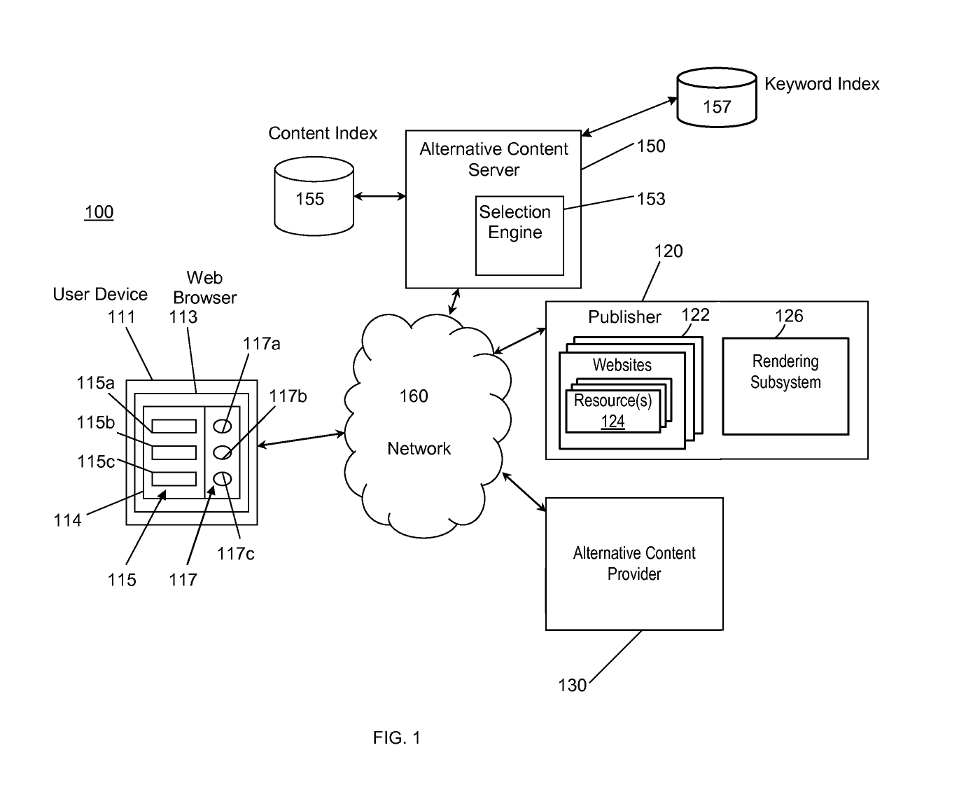

With reference to FIG. 1, an example system 100 for distributing content includes a user device 111 to which content is distributed, and a publisher system 120 of a publisher that maintains (e.g., manages, owns) one or more websites 122. The system 100 also includes an alternative content provider system 130 (e.g., a system of an advertiser) that provides alternative content (e.g., advertisements) for distribution to users. The system 100 further includes an alternative content server 150 (e.g., an advertising server) for selecting alternative content distribution for available spaces included in publishers' content, or other requested content.

The example system 100 also includes a network 160 such as a local area network (LAN), wide area network (WAN), the Internet, or a combination thereof. The network 160 connects websites 122, user devices 111, the alternative content provider system 130, and the alternative content server 150. The example system 100 can include many thousands of user devices 111, alternative content provider systems 130, and websites 122.

A website 122 is one or more resources 124 associated with a domain name and hosted by one or more servers. An example website 122 is a collection of web pages formatted in hypertext markup language (HTML) that can contain text, images, multimedia content, and programming elements, e.g., scripts. The publisher system 120 includes a rendering subsystem 126 for generating code (e.g., HTML, scripts) for a web page.

A resource 124 is any data that can be provided by the website 122 over the network 160 and that is associated with a resource address. Resources 124 include HTML pages, word processing documents, and portable document format (PDF) documents, images, video, and feed sources, to name only a few. The resources 124 can include content, e.g., words, phrases, images and sounds that may include embedded information (such as meta-information in hyperlinks) and/or embedded instructions (such as JavaScript scripts).

The user device 111 is an electronic device that is under control of a user and is capable of requesting and receiving resources 124 over the network 160. Example user devices 111 include personal computers, mobile communication devices, and other devices that can send and receive data over the network 160. A user device 111 can request resources 124 from a website 122. In turn, data representing the resource 124 can be rendered by the rendering subsystem 126 and provided to the user device 111 for presentation by the user device 111, such as in a web browser application 113. Web browser applications 113 can include, for example, Internet Explorer™ offered by Microsoft Inc., Google Chrome™ offered by Google Inc., Opera™ offered by Opera Software ASA, Safari™ offered by Apple Inc., and Firefox™ offered by Mozilla Corporation. A web browser application also may be referred to as a web browser.

The web browser 113 can facilitate the sending and receiving of data over the network 160 and is operable to output a display to the user and/or to receive inputs from the user, such as keystrokes, pointer clicks, voice commands, and/or another inputs. The web browser 113 in the example of FIG. 1 is displaying an example web page 114 rendered from HTML code generated by the rendering subsystem 126. The example web page 114 includes a first area 115 for display of content 115a-115c from a first source, such as content provided by the publisher system 120. The example web page 114 also includes a second area 117 for display of alternative content 117a-117c from a second source, such as advertisements selected by the alternative content server 150 from among available advertisements provided by one or more alternative content provider systems 130.

To have content from multiple sources displayed in the example web page 114, the rendering subsystem 126 can generate HTML code which includes the use of one or more “iframes,” where each iframe represents an area of the example web page 114 used to display content from a content source. For example, a first iframe can be used to display content 115a from the publisher system 120 and a second iframe can be used to display content 117a from the alternative content provider system 130. The first and second iframes may be referred to as children of the example web page 114, and the example web page 114 may be referred to as the parent of the first and second iframes. Other iframes can be used to display other content, such as separate iframes for each of the content 115b-115c and the alternative content 117b-117c.

An iframe can be an external iframe or a “friendly” iframe. An external iframe has a coded source attribute referring to a resource on an external server. A friendly iframe is from the same domain as its parent and may not necessarily have a source attribute specified. The web page 114 may include content that is not included in an iframe. In some implementations, most content of a web page is not included in an iframe.

The rendering subsystem 126 can generate script code (e.g., JavaScript) to be executed by the web browser 113. Script code can be associated with an iframe (e.g., a script tag can be included inside of an iframe tag) or script code can be associated with the example web page 114 but not specifically associated with a particular iframe (e.g., a script tag can be included in the HTML code for the example web page 114 without being inside of any iframe tags). Script code can be internal (e.g., included in the HTML code generated by the rendering subsystem 126) or external (e.g., a script tag can have a coded source attribute which refers to a code file located on an external server, such as on the alternative content server 150 or on another server).

The example web page 114 is represented by the web browser 113 as a set of document objects. A document object representing the contents of the example web page 114 as a whole may be referred to as a parent document object, and each iframe in the example web page 114 may be referred to as a child document object. For example, to process the example web page 114, the web browser 113 can create seven document objects (e.g., a parent document object and six child document objects, one for each of six iframes used to display the content 115a-115c and the alternative content 117a-117c). If an iframe is a friendly iframe with no source attribute specified, then the document object for the friendly iframe is initially empty (e.g., having no content).

A document object can be accessed by script code. For example, a script can include a “document.write” instruction which appends text to a document object. A “document.write” instruction can be interpreted by the web browser 113 to refer to either a parent document object or a child document object, depending on the location of the instruction within the HTML code. For example, a “document.write” instruction which is not located inside of code for an iframe refers to the parent document object, whereas a “document.write” instruction which is located inside of a script which is located within code for an iframe refers to the child document object associated with the iframe. As another example, a document object reference can be fully qualified to include the name of the containing iframe object.

The web browser 113 can have a cross-domain restriction where script code inside of an external iframe tag is restricted from communicating with the parent document object if the domain name specified in the source attribute of the external iframe refers to a different domain than the domain of the server from which the example web page 114 was received. A cross-domain restriction can be helpful in providing some security against malicious code. A cross-domain restriction can be challenging in some circumstances by hindering inter-object communication. In an advertising environment, it may be desirable for script code within an iframe to be able to communicate with the parent document object. For example, such communication may be desirable to ensure that an advertisement to be displayed in the iframe is not a duplicate of another advertisement already displayed in another iframe of the example web page 114. Therefore, to avoid a cross-domain restriction, a friendly iframe (e.g., an iframe which does not refer to an external server) can be used. Additionally, some web pages may alter the cross-domain-communications rules by setting the “document.domain” property, and in some browsers, this interferes with the ability of a friendly iframe to interact with its parent window. This can cause problems if the “document.domain” property is not set at the time the document.write instruction is loaded into the friendly iframe, but does get set later on (e.g., by unrelated JavaScript code executing in the parent window). In some implementations, the external script restores communication by altering the “document.domain” property inside the friendly iframe, when necessary. For example, possible values for the “document.domain” property can be set in turn, in a trial-and-error sort of way, to find out which one permits communication with the parent window.

Another limitation of the web browser 113 is that the web browser 113 can be single threaded such that an operation to download or execute a script can be a blocking operation. For example, when the web browser 113 is processing the HTML code for the example web page 114 and encounters a script tag, the web browser 113 may be blocked from doing other processing while processing the script. As another example, the web browser 113 can be blocked while downloading (as well as parsing and executing) an external script.

An approach can be used to enable the web browser 113 to perform execution of rendering of content within an iframe while the web browser 113 continues to render other content of the example web page 114. For example, the rendering subsystem 126 can generate HTML code to create an empty (e.g., friendly) iframe on the example web page 114. The rendering system 126 can generate script code to place content into the iframe. For example, the rendering system 126 can generate a script tag which includes a “document.write” instruction which injects other script code into the child document object associated with the iframe. The injected script code can refer to script code on an external server (e.g., the alternative content server 150).

Importantly, the web browser 113 can process a child document object independently of processing the parent document object. Therefore, the web browser 113 can process the script code injected into the child document object associated with the iframe while continuing to process the parent document associated with the example web page 113. Since the iframe is coded as a friendly iframe, the script code injected into the iframe can communicate with the parent document object (e.g., to ensure that alternative content displayed in the iframe is not a duplicate of other alternative content displayed on the example web page 114). The web browser 113 can process script code injected into a first iframe (e.g., an iframe corresponding to alternative content 117a) while processing script code injected into a second iframe (e.g., an iframe corresponding to alternative content 117b).

Script code injected into an iframe can request alternative content from the alternative content server 150. In response to receiving the request for alternative content, a selection engine 153 of the alternative content server 150 selects an appropriate number of pieces of content for distribution to the user device 111 from among candidate pieces of content referenced in one or more indices, such as indices 155 and 157. In some implementations, the index 157 is a keyword-based index which is used to select pieces of alternative content based on keywords included in the request, and the index 155 is a content-based index which is used to select pieces of alternative content based on the content 115a-115c requested from the publisher system 120, as indicated in the request for alternative content.

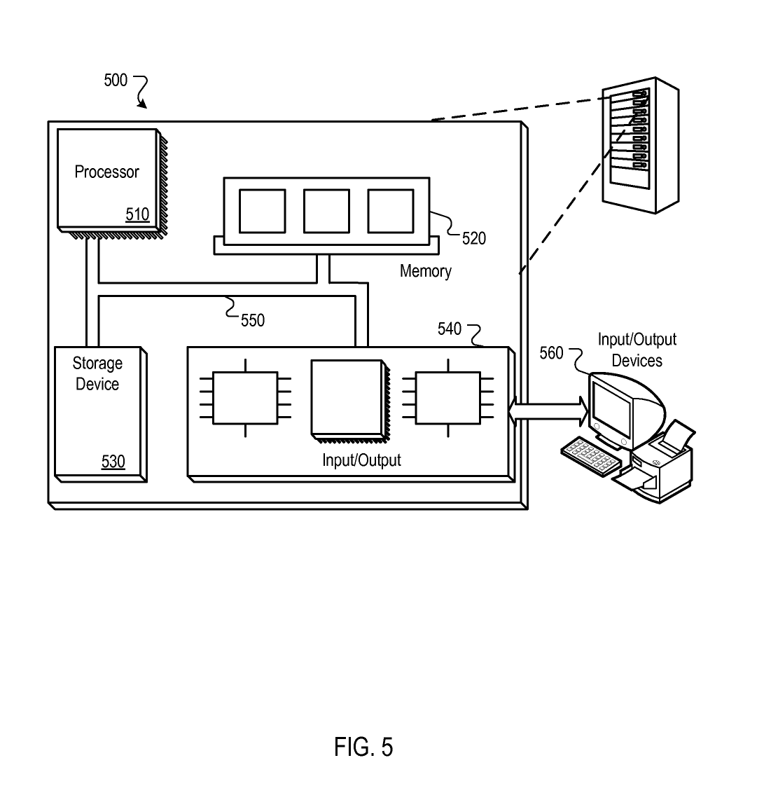

One or more of the components of the system 100, such as the user device 111, the publisher system 120, the alternative content provider system 130, and/or the alternative content server 150, can include one or more computer systems, such as the computer system 500 of FIG. 5. The computer system 500 includes a processor 510, memory modules 530, a storage device 520, and an input-output module 540 connected by a system bus 560. The input-output module 540 is operable with one or more input and/or output devices 550, including a communication device for operable connection with a network 160 and with the other components of the system 100. The one or more computer systems 500 can perform the various functions of the components of the system 100 by executing computer-readable instructions, such as computer software stored on a computer-readable storage device.

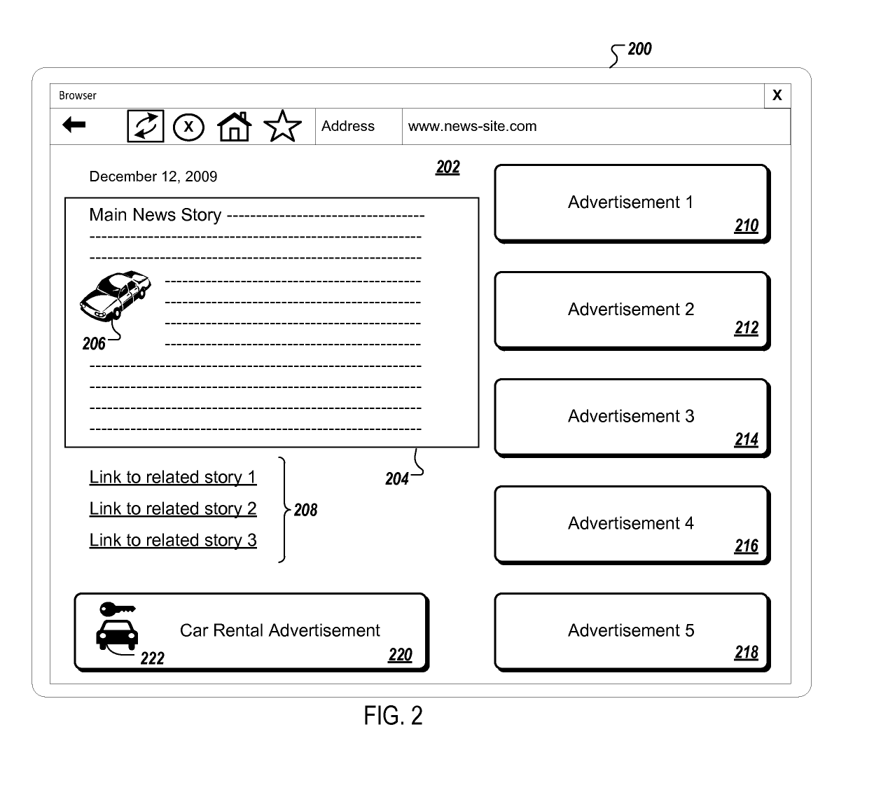

FIG. 2 is a block diagram of an example web browser 200. The web browser 200 is displaying an example web page 202. The example web page 202 includes publisher content 204. The publisher content 204 can be provided, for example, by the publisher system 120 (as referenced above with respect to FIG. 1). The publisher content 204 can include text, one or more graphics 206, and other multimedia content (e.g., the publisher content 204 can include one or more resources 124 as described above with reference to FIG. 1). The web page 202 can also include one or more links 208 to other content. The links 208 can link to content from the same publisher that provided the content 204 or to other content.

The web page 202 can also include one or more areas 210-220 for displaying alternative content, such as advertisements. The areas 210-220 can be used to display text advertisements, or advertisements that include one or more graphics (e.g., graphic 222) or other resources. As mentioned above with respect to FIG. 1, the rendering subsystem 126 can generate HTML and script code so that when the HTML and script code is executed by the web browser 200, rendering of alternative content in the areas 210-220 can be performed in parallel with rendering of the publisher content 204.

Parallel rendering of the content 204 along with rendering of alternative content displayed in one or more areas 210-220 can be accomplished by using the approach described above with reference to FIG. 1 of creating an empty iframe for each of the areas 210-220 and by injecting script code for each iframe into a child document object associated with the iframe. The injected script code can refer to a script located on an external server. The web browser 200 can process each child document object independently (and independently of processing a parent document object associated with the web page 202), thereby enabling parallel processing of script code injected into each document object and enabling parallel rendering of the content displayed in the areas 210-220 and of the publisher content 204.

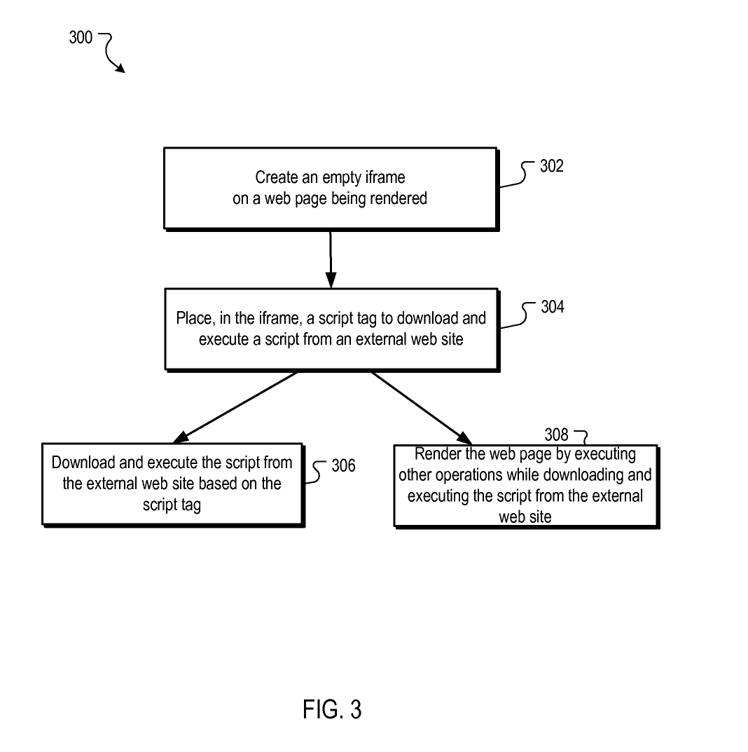

FIG. 3 is a flow chart of an example process 300 for rendering a web page including content from multiple web sites. The process 300 can be performed, for example, by the example system 100 (discussed previously with respect to FIG. 1). The process 300 includes creating an empty iframe on a web page being rendered (302). For example and with reference to FIG. 1, the rendering subsystem 126 can generate HTML code for the example web page 114, where the HTML code includes an iframe tag which does not include a source attribute. The web browser 113 can, when loading the example web page 114, execute the iframe tag and create an associated document object, which can be initially blank (e.g., having no content). For example, the rendering subsystem 126 can generate HTML for the web page 114 which is similar to the example numbered code shown below in Table 1. The empty iframe is created when line one of the script shown in Table 1 is executed by the web browser 113. The empty iframe is named, but has no source attribute.

TABLE 1

| | |
|---|---|
| 1 | <iframe name=”ads iframe”></iframe> |
| 2 | <script> |

| | |
|---|---|
| 3 | window.frames[″ads_iframe″].document.open( ); |
| 4 | window.frames[″ads_iframe″].document.write( |

| | |
|---|---|
| 5 | [′<!DOCTYPE html> <html><body>′, |
| 6 | ′<script> running_in_dedicated_iframe = true; <\/script>′, |
| 7 | ′<script |
| | src=″http://www.example.com/some_script.js″><\/script>′, |
| 8 | ′<\/body><\/html>′].join(′\n′)) |

| | |
|---|---|
| 9 | </script> |

A script tag is placed in the iframe to download and execute a script from an external web site (304). For example and in reference to FIG. 1, the rendering subsystem 126 can generate a first script tag which includes JavaScript code for a first script. The first script can open a document object associated with the iframe and write a second script tag for a second script into the document object associated with the iframe. The second script tag can have a source attribute which refers to an external script file located on an external server. The external script file can include code to render content (e.g., to render content for an advertisement).

For example and in reference to Table 1, the first script begins on line two and ends on line nine. The second script is injected into the child document object associated with the iframe using the document.write instruction which begins on line four. The script on line seven is an example of the second script and refers to a script on a www.example.com external web site. A third script tag (the script tag on line six) is described in more detail below.

In some implementations, a web page may attempt to download the same script in two places on the page at the same time, such as where there are two advertisements being shown on the page, which may cause a problem in rendering the page. To avoid such a problem, a simple serialization queue can be added. For example, before placing the script tag inside the friendly iframe (described in paragraph [0036]), a check is performed to determine whether another script-write-into-friendly-iframe is in progress. If so, the document.write instruction of the second iframe is delayed until the previous one has finished.

The script is downloaded from the external web site and executed, based on the script tag (306). For example and in reference to FIG. 1, the web browser 113 can execute the second script tag and can refer to the source attribute specified on the second script tag to determine the location of an associated script on an external web site. The web browser 113 can download the script from the external web site and execute the script commands included in the downloaded script. For example and in reference to line seven of Table 1, the web browser 113 can download a some_script.js file from the server www.example.com and can execute the script statements included in the some_script.js file.

The web page is rendered by executing other operations while downloading and executing the script from the external web site (308). For example and in reference to FIG. 1, the web browser 113 can download and execute a script from an external web site that is associated with an iframe while continuing to render the remainder of the web page 114. Because the script tag for the external script is injected into a child document object associated with the iframe, the web browser 113 can process the child document object independently of processing the parent document object associated with the web page 113 and independently of processing other child document objects associated with other iframes included in the web page 113. Stated differently, a script injected into a child document object associated with the iframe can be loaded and executed in a non-blocking manner, and can be executed while other tasks are performed, such as rendering other portions of the web page 114. Specifically, in reference to Table 1, the web browser 113 is briefly blocked while performing the document.open instruction on line three and the document.write instruction beginning on line four. The web browser 113 is not blocked while the some_script.js file is downloaded from the www.example.com server and is not blocked while the statements included in the some_script.js file are executed.

Additionally, because the rendering subsystem 126 can generate iframe tags without source attributes, the web browser 113 does not enforce a cross-domain restriction, which enables the script code injected into the iframe to communicate with a parent document object (e.g., to ensure that alternative content displayed in the iframe is not a duplicate of other alternative content displayed in other iframes included in the web page 114).

For some types of web browsers, additional code can be needed to close a child document object associated with an iframe beyond simply using a document.close instruction. For example, in some versions of some web browsers, closing a child document object can result in that type of web browser stopping further execution of downloaded script code associated with the child document object. In some implementations, calling document.close after a brief (e.g., one millisecond) time delay may be necessary in some types of web browsers to work around a bug in the web browser. In some implementations, the downloaded script code can include, as a last line of code, an instruction to call document.close after a brief time delay. In some implementations, the call to document.close can be conditional based on whether the script is called as a result of being used with an iframe. For example and in reference to Table 1, a test can be performed to determine whether a flag variable such as “running_in_dedicated_iframe” has been set (e.g., as set by an example third script included on line seven of Table 1).

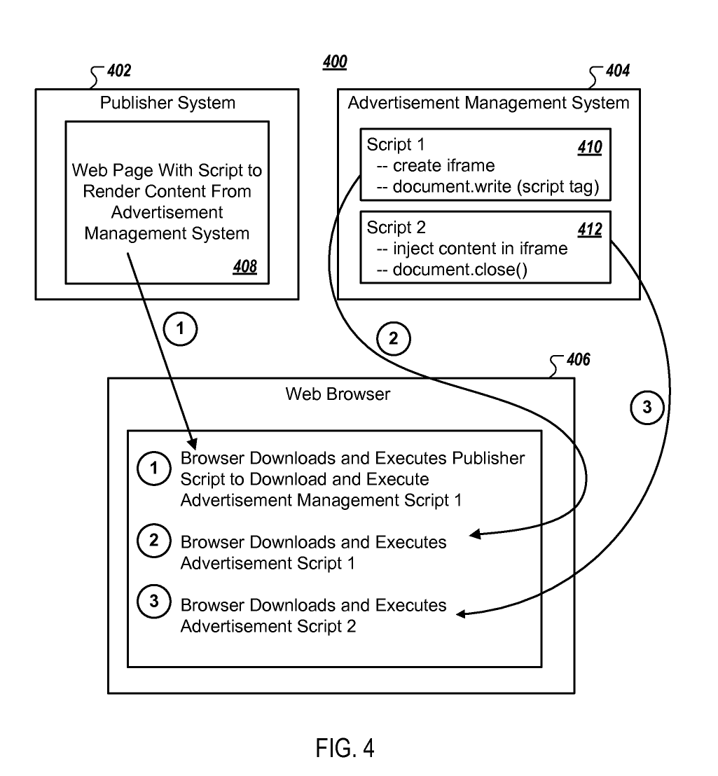

FIG. 4 illustrates an example system 400 for distributing content. The system 400 includes a publisher system 402, an advertisement management system 404, and a web browser 406. The publisher system 402 includes a web page 408 which includes a publisher script to render content from advertisement management system 404. For example, the web page 408 can be coded so that in response to a request by the web browser 406 to load the web page 408, publisher content from the publisher system 402 can be displayed in the web browser 406, along with advertising content from the advertisement management system 404.

As indicated by step one, the web browser 406 downloads the web page 408 which results in the execution of the publisher script. The publisher script includes an instruction (e.g., an embedded script tag) to download and execute a first advertisement script 410 from the advertisement management system 404. As indicated by step two, the web browser 406 downloads and executes the first advertisement script 410. The downloading, parsing, and executing of the first advertisement script 410 blocks the web browser 406 from performing other actions until the first advertisement script 410 completes. The first advertisement script 410 includes instructions to create an empty iframe (e.g., a friendly iframe with no specified source attribute). The first advertisement script 410 also includes an instruction to write text into a child document object associated with the iframe. The text written into the iframe's document object includes a script tag which refers to a second advertisement script 412.

As indicated by step three, the web browser 406 processes the document object associated with the iframe and downloads and executes the second advertisement script 412 from the advertisement management system 404. Importantly, as described above with respect to FIG. 1, processing a child document object associated with an iframe does not block the web browser 406 from completing other tasks, such as rendering other portions of the web page 408. Therefore, the web browser 406 can execute the second advertisement script 412 while performing other work. The second advertisement script 412 includes instructions to inject content (e.g., advertising content) into the iframe. The second advertisement script 412 also includes an instruction to close the child document object associated with the iframe.

FIG. 5 is block diagram of an example computer system 500 that can be used to distribute content. The system 500 includes a processor 510, memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, or some other large capacity storage device.

The input/output device 540 provides input/output operations for the system 500. In one implementation, the input/output device 540 can include one or more of a network interface device, e.g., an Ethernet card, a serial communication device, e.g., an RS-232 port, and/or a wireless interface device, e.g., an 802.11 card. In another implementation, the input/output device can include driver devices configured to receive input data and send output data to other input/output devices, e.g., keyboard, printer and display devices 560. Other implementations, however, can also be used, such as mobile computing devices, mobile communication devices, set-top box television client devices, etc.

The rendering subsystem 126 can be realized by instructions that upon execution cause one or more processing devices to carry out the processes and functions described above. Such instructions can comprise, for example, interpreted instructions, such as script instructions, e.g., JavaScript or ECMAScript instructions, or executable code, or other instructions stored in a computer readable medium. The rendering subsystem 126 and/or alternative content server 150 can be distributively implemented over a network, such as a server farm, or can be implemented in a single computer device.

Although an example processing system has been described with reference to FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier for execution by, or to control the operation of, a processing system. The computer readable medium can be a machine readable storage device, a machine readable storage substrate, a memory device, a composition of matter effecting a machine readable propagated signal, or a combination of one or more of them.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on a computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of the invention or of what may be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the invention have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer program tangibly embodied in a computer-readable medium, the computer program having instructions that, when executed by at least one processor, cause the at least one processor to render a web page including content from multiple web sites by performing operations comprising:
executing a first operation to create an empty iframe on a web page being rendered, the iframe being created without content;
executing a second operation to place content in the iframe, wherein:
the content comprises a script tag to download and execute a script from a web site, and
the second operation is different from the first operation;
based on the script tag, downloading and executing the script from the web site;
executing an additional operation to render the web page concurrently with executing at least one operation in the script downloaded from the web site,
wherein:
the additional operation is an operation other than the first operation and the second operation,
the web site is a second web site that is different from a first web site that supplied the instructions to render the web page, and
the rendered web page includes content from the first web site and content from the second web site.

2. The computer program of claim 1 wherein the first operation comprises an operation to create an iframe without a source attribute.

3. The computer program of claim 1 wherein the first operation comprises an operation to create an iframe having a document object that is blank.

4. The computer program of claim 1 wherein the second operation comprises a JavaScript document.write( )method.

5. The computer program of claim 4 wherein:
the script tag identifies an external source, and
the JavaScript document.write( )method injects the script tag into the iframe.

6. The computer program of claim 1 wherein the script downloaded from the second web site includes a command to close a document object in the iframe.

7. The computer program of claim 6 wherein the script downloaded from the second web site includes calls a JavaScript document.close( )method.

8. The computer program of claim 6 wherein the web page comprises a web page including content from a publisher site and the iframe on the web page displays an advertisement on the rendered page.

9. The computer program of claim 1 wherein:
the operations include:
downloading a publisher script from the first web site, and
executing the publisher script to download a first advertisement script from the second web site, and
executing the first advertisement script comprises executing the first operation to create the empty iframe and executing the second operation to place, in the iframe, a script tag identifying a second advertisement script from the second web site.

10. A computer-implemented method for rendering a web page including content from multiple web sites, the method comprising:
executing a first operation to create an empty iframe on a web page being rendered, the iframe being created without content;
executing a second operation to place content in the iframe, wherein:
the content comprises a script tag to download and execute a script from a web site, and
the second operation is different from the first operation;
based on the script tag, downloading and executing the script from the web site;
executing an additional operation to render the web page concurrently with executing at least one operation in the script downloaded from the web site,
wherein:
the additional operation is an operation other than the first operation and the second operation,
the web site is a second web site that is different from a first web site that supplied the instructions to render the web page, and
the rendered web page includes content from the first web site and content from the second web site.

11. The method of claim 10 wherein the first operation comprises an operation to create an iframe without a source attribute.

12. The method of claim 10 wherein the first operation comprises an operation to create an iframe having a document object that is blank.

13. The method of claim 10 wherein the second operation comprises a JavaScript document.write( )method.

14. The method of claim 13 wherein:
the script tag identifies an external source, and
the JavaScript document.write( )method injects the script tag into the iframe.

15. The method of claim 10 wherein the script downloaded from the second web site includes a command to close a document object in the iframe.

16. The method of claim 15 wherein the script downloaded from the second web site includes calls a JavaScript document.close( )method.

17. The method of claim 15 wherein the web page comprises a web page including content from a publisher site and the iframe on the web page displays an advertisement on the rendered page.

18. The method of claim 10 wherein:
the operations include:
downloading a publisher script from the first web site, and
executing the publisher script to download a first advertisement script from the second web site, and
executing the first advertisement script comprises executing the first operation to create the empty iframe and executing the second operation to place, in the iframe, a script tag identifying a second advertisement script from the second web site.

19. A computer system for rendering a web page including content from multiple web sites, the system comprising at least one processor and at least one input/output device, the at least one processor configured to perform operations comprising:
executing a first operation to create an empty iframe on a web page being rendered, the iframe being created without content;
executing a second operation to place content in the iframe, wherein:
the content comprises a script tag to download and execute a script from a web site, and
the second operation is different from the first operation;
based on the script tag, downloading and executing the script from the web site;
executing an additional operation to render the web page concurrently with executing at least one operation in the script downloaded from the web site,
wherein:
the additional operation is an operation other than the first operation and the second operation,
the web site is a second web site that is different from a first web site that supplied the instructions to render the web page, and
the rendered web page includes content from the first web site and content from the second web site.

20. The system of claim 19 wherein the first operation comprises an operation to create an iframe without a source attribute.
